(19) United States
(12) Patent Application Publication
(10) Pub. No.: US 2007/0152955 A1
(43) Pub. Date: Jul. 5, 2007

(54) Reduced power consumption display panel

(75) Inventors: Juha H-P Nurmi, Salo (FI); Kaj Saarinen, Turku (FI)

Correspondence Address: HARRINGTON & SMITH, PC, 4 RESEARCH DRIVE, SHELTON, CT, 06484-6212, US

(73) Assignee: Nokia Corporation

(21) Appl. No.: 11/323,390

(22) Filed: Dec. 29, 2005

(51) Int. Cl. G09G 3/36

(52) U.S. Cl. 345/103

(57) ABSTRACT

A display device is formed of a first display panel coupled to a first common voltage, and at least one additional display panel coupled to at least one additional common voltage, wherein the first display panel and the at least one additional display panel are coupled to form a single expanse.

### TECHNICAL FIELD

This invention relates generally to a reduced power consumption display

### BACKGROUND

It is common to provide electronic computing devices with display devices to facilitate the visualization of graphic elements. With reference to FIG. 1, there are illustrated the basic components of such a display device known in the prior art. A processor 11, typically embodied in a flexible printed circuit (FPC), is coupled to a display panel 21 via display driver 17. The display driver 17 translates the logical instructions received from the processor 11 into an output signal for transmission to the display panel 21, so as to control the individual picture elements, or pixels, that form display area 13. Examples of such display panels include Active Matrix Displays or thin film transistor (TFT) displays each comprised of liquid crystal display (LCD) pixels (hereinafter “pixels”).

Typically, the formation of an image upon display panel 21 requires that each pixel forming the display area 13 of the display panel 21 be maintained at a common voltage, VCOM. Common video source signals range from approximately 0V to 10V and provide intensity information that appears across each pixel as a voltage. One side of each pixel is commonly connected to the backplane of the display panel 21 at a node common to all pixels. The voltage at this node is referred to as VCOM.

In some implementations, VCOM is maintained at ground, or 0V. Such a set-up, while functional, reduces display panel 21 lifetime. When VCOM is at ground, the voltage across individual pixels can, using the exemplary parameters noted above, vary from 0V to 10V. Under such a scenario, the average voltage across any single pixel over time is approximately 5V forming a near constant DC voltage across each pixel. This DC voltage can cause charge storage, or memory. Over time, this charge storage tends to degrade pixels by electroplating ion impurities onto one of the electrodes forming a pixel. As a result, a residual, or sticking image, is permanently burned into the display.

Because the construction of LCD panels is symmetrical, either a positive or a negative voltage can be used to align the crystals. This aspect of LCD display panels can be used to increase the longevity of LCD displays. Specifically, the VCOM can be moved to a value approximating the midpoint of the video signal. This causes the video signal voltage to swing both above and below the VCOM resulting in a net zero voltage effect on each pixel. This net zero effect serves to largely eliminate the aging and retention issues discussed above.

Typical values for VCOM range from 0V to approximately 5V. Depending on the overall intensity of an image displayed on the display panel, the average voltage across the pixels forming the display will vary from frame to frame. It is therefore preferable to make adjustments to the applied VCOM periodically, such as between sequential frames, so that VCOM more closely approximates an instantaneous average voltage across all of the pixels.

Maintaining the entire display area 13 at VCOM, even for an abbreviated period of time, requires energy. In many mobile devices, such as mobile telephones, the repeated provision of the VCOM to the display area 13 results in diminished battery life.

Often times, it is only required that a portion of the display area 13 be updated with an image. For example, partial display area 15 forms a generally vertical portion of display area 13. Areas such as partial display area 15 are often utilized to display specialized indicia and data such as battery and signal strength, time of day, network status, operator name, etc. In such instances, updating only the indicia or the data, each contained entirely within partial display area 15, requires providing VCOM to the entire display area 13.

What is needed is an apparatus to facilitate the alteration of a portion of the display area 13, such as partial display area 15, that does not require the provision of an unnecessary voltage to the display area 13.

### SUMMARY OF THE PREFERRED EMBODIMENTS

In accordance with an exemplary embodiment of the invention, a display device includes a first display panel coupled to a first common voltage, and at least one additional display panel coupled to at least one additional common voltage, wherein the first display panel and the at least one additional display panel are coupled to form a single expanse and the first common voltage and the at least one additional common voltage are independently controllable.

In an alternative exemplary embodiment of the invention, a display module includes a display device formed of a first display panel coupled to a first common backplane, and a second display panel coupled to a second common backplane, wherein the first display panel and the second display panel are coupled to form a single expanse, a source driver having an input coupled to a display data source and an output coupled to the display device, and a common driver coupled to the source driver and to the first and second common backplane, wherein the common driver differentially controls a first common voltage provided to the first common backplane and a second common voltage provided to the second common backplane.

In an alternative exemplary embodiment of the invention, a method of controlling a display device includes providing a display device including a first display panel coupled to a first common backplane, and at least one additional display panel coupled to at least one additional common backplane, wherein the first display panel and the at least one additional display panel are coupled to form a single expanse, displaying display data on at least one of the first display panel and the at least one additional display panel, and independently providing at least one common voltage to each of the first common backplane and the at least one additional common backplane on which there is displayed display data.

In an alternative exemplary embodiment of the invention, a portable electronic device includes a display device comprising a first display panel coupled to a first common voltage, and at least one additional display panel coupled to at least one additional common voltage, wherein the first display panel and the at least one additional display panel are coupled to form a single expanse, and a processor coupled to the display device for controlling operation of the display device.

In an alternative exemplary embodiment of the invention, a program of machine-readable instructions is tangibly embodied on an information bearing medium and executable by a digital data processor performs actions directed toward providing a plurality of common voltages to a display device, the actions including receiving display data to be displayed on a display device comprising a first display panel coupled to a first common backplane and at least one additional display panel coupled to at least one additional common backplane, computing a first common voltage and at least one additional common voltage, and providing the first common voltage to the first common backplane and the at least one additional common voltage to the at least one additional common backplane.

In an alternative exemplary embodiment of the invention, an apparatus includes a means for receiving display data to be displayed on a display device comprising a first display panel coupled to a first common backplane and at least one additional display panel coupled to at least one additional common backplane, a means for computing a first common voltage and at least one additional common voltage, and a means for providing the first common voltage to the first common backplane and the at least one additional common voltage to the at least one additional common backplane.

### BRIEF DESCRIPTION OF THE DRAWINGS

The foregoing and other aspects of these teachings are made more evident in the following Detailed Description, when read in conjunction with the attached Drawing Figures, wherein:

FIG. 1 is an illustration of a display panel known in the art.

FIG. 2 is a diagram of an exemplary embodiment of the display device of the invention.

FIG. 3 is a diagram of an exemplary embodiment of the display device of the invention.

FIG. 4 is a diagram of an exemplary embodiment of the display device of the invention.

FIG. 5 is a diagram of an exemplary embodiment of a display device of the invention implemented in a mobile device.

FIG. 6 is a diagram of an exemplary embodiment of a display module of the invention.

FIG. 7 is a diagram of an exemplary embodiment of a portion of a display device of the invention.

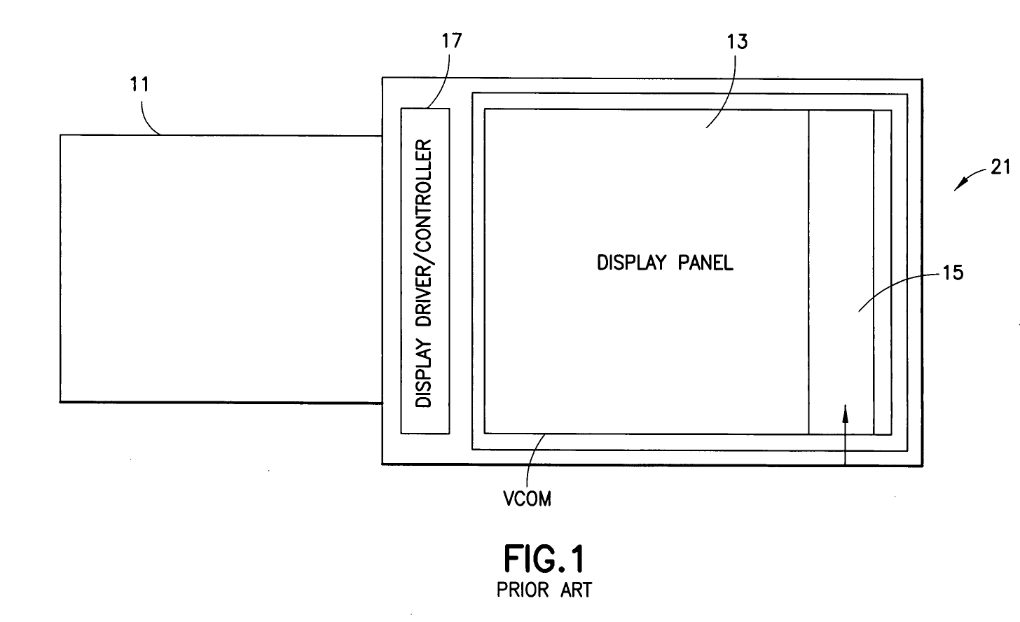

### DETAILED DESCRIPTION

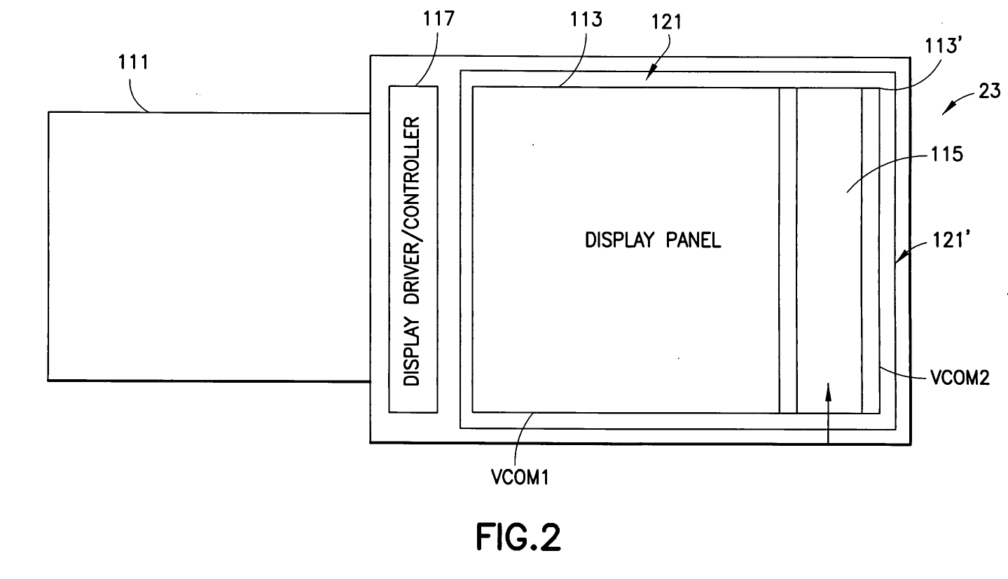

With reference to FIG. 2, there is illustrated an exemplary embodiment of the invention, wherein there is provided a display device 23 for the presentation of graphic data. The display device 23 is formed of more than one display panel 121, 121′ each having a display area 113, 113′. As illustrated, the combination of the display areas 113, 113′ form a single, substantially unbroken expanse which in turn forms the total display area of display device 23. By dividing the display device 23 into two or more display panels, it is possible to independently control the production of images upon each display panel 121, 121′.

In the example illustrated, partial area 115 forms a portion of display area 113′. Partial area 115 can form any portion of display area 113′ up to, and including, all of display area 113′. Note that each display panel 121, 121′ is coupled to a separate common voltage, VCOM1, VCOM2, respectively. More specifically, each display panel is associated with a separate and individual common backplane to which is applied an individual VCOM as described more fully below. As a result, VCOM1 can be utilized to power the functioning of display panel 121 independent of the energy or graphic requirements of display panel 121′. Conversely, VCOM2 can be utilized to power the functioning of display panel 121′ independent of the energy or graphic requirements of display panel 121. In practice, the VCOM used to power each display panel 121 can be of the same value.

As is described more fully below, while utilizing separate common voltages, VCOM1, VCOM2, both display panels 121, 121′ can be operated by the same display driver 117.

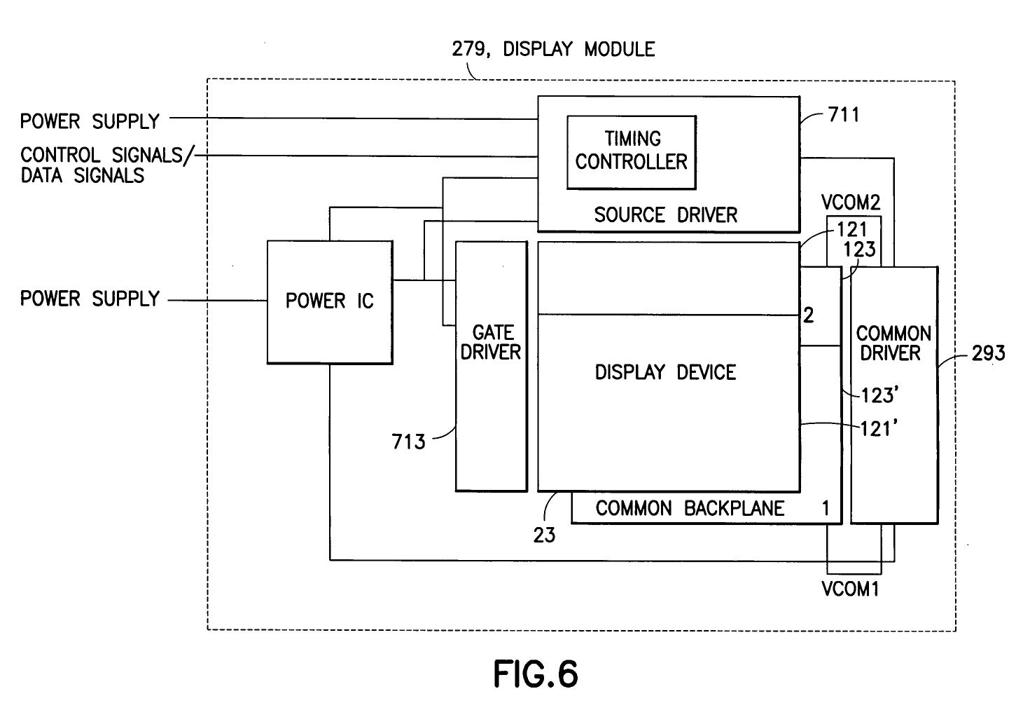

With reference to FIG. 6, there is illustrated a diagram of an exemplary embodiment of a display module 279 formed of a display device 23 having two display panels 121, 121′ wherein the pixels forming each display panel 121, 121′ are attached to separate common backplanes 123, 123′ respectively. As noted, each common backplane 123, 123′ can be provided with a separate, and potentially different, VCOM. Each VCOM may be statically provided or, preferably, may be periodically altered, such as between frames, to more closely track the average signal voltage applied across the pixels forming the display panels 121, 121′.

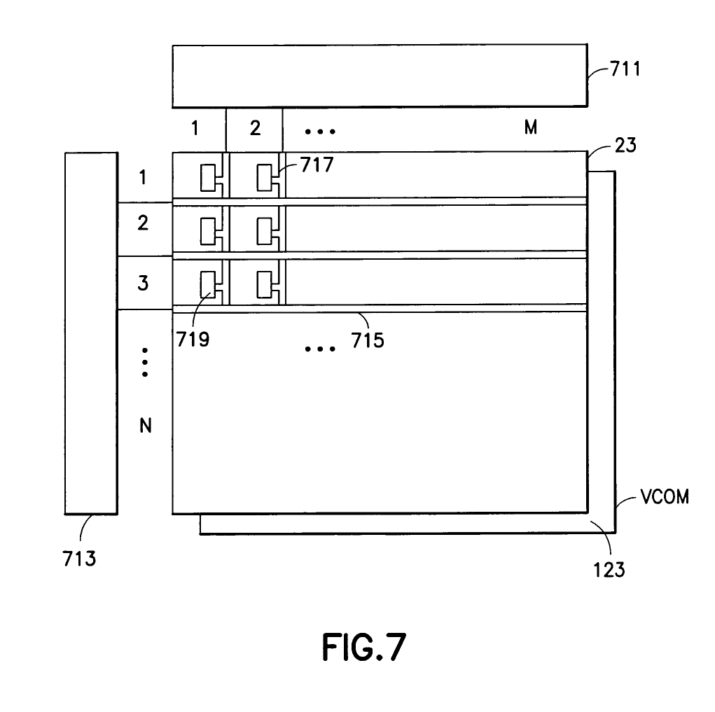

As described, each display panel 121, 121′ is a logical division of the physical display device 23 upon which an image can be formed. The measurements of each display panel 121, 121′ correspond to the physical dimensions of each associated common backplane 123, 123′ respectively. As described more fully below with reference to FIG. 7, the display device 23 is formed of a plurality of pixels arranged in rows and columns wherein each pixel is independently accessible by a single gate bus line 715 and source bus line 717. The gate driver 713 physically spans one dimension of the display device 23 while the source driver 711 spans the other orthogonal dimension. As illustrated, the vertical span of the gate driver 713 corresponds to the columns of pixels while the horizontal span of the source driver corresponds to the rows of pixels.

With reference to FIG. 7, there is illustrated an exemplary embodiment of a portion of display device 23. A plurality of source bus lines 717, one for each column of pixels in display device 23, extends vertically across display device 23. Each source bus line 717 is coupled to the source driver 711. Likewise, a plurality of gate bus lines 715, one for each row of pixels in display device 23, extends horizontally across display device 23. Each gate bus line 715 is coupled to the gate driver 713. At the intersection of each gate bus line 715 and source bus line 717, there is a pixel 719.

When provided with an image to display, for example an N×M pixel image, the source driver 711 provides the voltages corresponding to the intensity of the first row of pixels across source bus lines 1-M. Gate driver 713 then applies a voltage to gate bus line 1. As a result of the gate driver 713 applying such a voltage, all of the pixels 719 across the first row of display panel 23 assume their appropriate intensities. Source driver 711 next provides the voltages corresponding to the intensity of the second row of pixels across source bus lines 1-M. Gate driver 713 then applies a voltage to gate bus line 2. This process repeats itself until all N rows of the image have been displayed. A timing controller in the source driver 711 controls the timing of when the voltages applied to source bus lines 717 and gate bus lines 715 are refreshed.

With continued reference to FIG. 6, common driver 293 is coupled to the source driver 711 and provides individual common voltages, VCOMs, to each common backplane 123, 123′. In this manner, common driver 293 is capable or receiving information detailing the portions of display device 23 on to which an image is to be displayed. In addition, common driver 293 is capable of determining which display panels 121, 121′ will be utilized for displaying the image. Common driver 293 is further capable of providing individual VCOMs to each common backplane 123, 123′ associated with the display panels 121, 121′ to be utilized. As noted above, each VCOM can have a statically determined value or, preferably, is dynamically computed and provided by common driver 293. In this manner, common driver 293 serves as a means to differentially control the operation of each individual common backplane 123, 123′ in response to the individual display panels 121, 121′ to be utilized in forming a display.

As noted above, the common voltage, VCOM, is applied to each pixel 719 via a common backplane 123. Source driver 711 receives control and data signals, such as from display driver 117. As will be described more fully below, one or more display drivers 117 can send image information to source driver 711 for display upon display device 23.

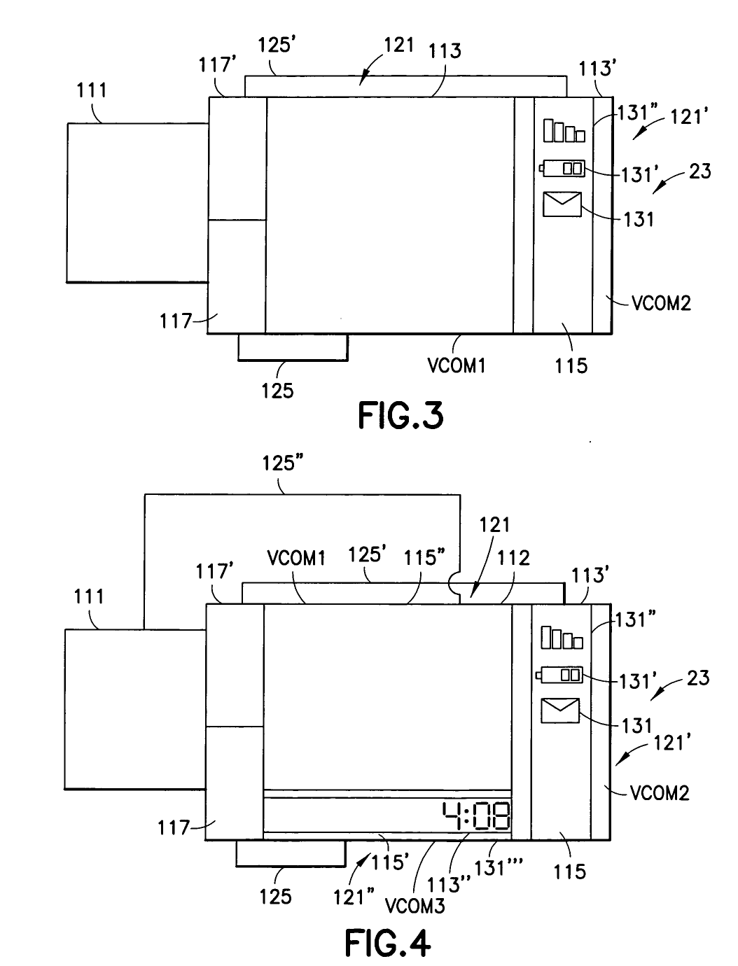

With reference to FIG. 3, there is illustrated an alternative exemplary embodiment of the invention. In the present example, there is incorporated the use of an additional display driver 117′. As illustrated, display driver 117 is coupled to display panel 121. The logical couplings between various sources of display data, such as the display drivers 117, are preferably implemented by coupling each source to the various display panels via an intermediate coupling to the source driver 711 as described above. Likewise, display driver 117′ is coupled to display panel 121′. Display drivers 117, 117′ are any devices, including but not limited to graphics cards, capable of receiving instructions from a logic unit, such as processor 111, and converting such instructions into an output signal utilized to create an image upon a display panel 121, 121′. Typically, display drivers 117, 117′ are formed of internal memory dedicated to the graphic functionality performed upon an individual display driver 117, 117′.

In operation, the display drivers 117, 117′ receive input data from the processor 111. An example of such input data is data indicative of a signal strength to be displayed and further indicative of a signal strength value of four. Display driver 117′ receives this input and proceeds to control the functioning of individual pixels so as to create graphical indicia 131″ formed of four vertical bars. In a similar manner, device driver 117′ can proceed to control the display of alternative indicia 131, 131′ displaying the presence of a voice message and a battery strength respectively. While illustrated with respect to the presentation of graphical indicia 131, 131′, 131″, the output of the display driver 117′ is not so limited. Rather the output of display driver 117′ can be utilized to control a subset or all of the pixels forming partial area 115.

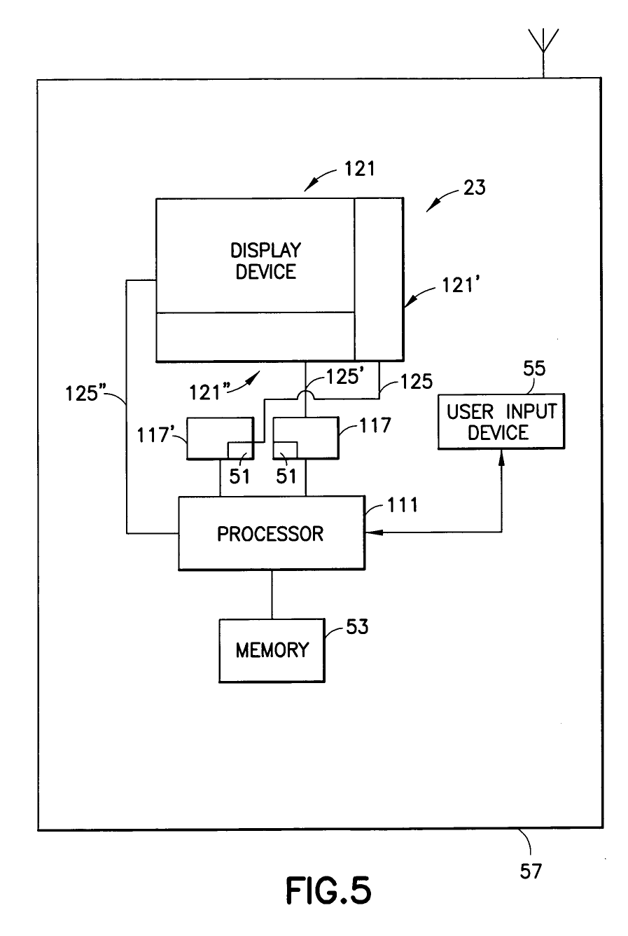

With reference to FIG. 4, there is illustrated an alternative exemplary embodiment of the invention. In the embodiment illustrated, display device 23 is formed of three display panels 121, 121′, and 121″ wherein each is formed of a display area 113, 113′, 113″ respectively. Note that two display drivers 117, 117′ are utilized to control the creation of images within each partial area 115, 115′. The creation and display of images upon display panel 121 is controlled via logical connection 125″ by the processor 111. While it is sometimes preferable to control the operation of one or more display panels 113′, 113″ via a display driver 117′, 117, respectively, it is not necessary to do so. In instances where the processor 111 has sufficient processing power to perform the required graphics related functionality, the processor 111 can perform some or all of the required graphics processing for one, or more than one, display panel 121, 121′, 121″.

While illustrated with embodiments wherein discreet graphical indicia 131-131′″ are displayed within discreet partial areas 115-115″, the invention is not so limited. If required, a single image can span more than one display panel 121. Doing so, however, requires the provision of a common voltage VCOM to more than one display panel 121 and thus reduces the power savings evident when only a single display panel 121 is utilized to display an image or graphical indicia 131. By selectively activating less than all of the display panels 121, the processor 111, often acting via a display driver 117, is able to reduce the power required by the display device 23. When operating in such a selectively activated mode, the display device 23 is deemed to be operating in a “partial mode”.

With reference to FIG. 5, there is illustrated a diagram of an exemplary embodiment of an implementation of the invention in a mobile device or station 57. In a preferred embodiment, mobile station 57 is a mobile telephone. Mobile station 57 is formed of a user input device 55 coupled to the processor 111. Processor 111 is coupled to at least one display panel 121, both display drivers 117, 117′ and a memory 53 upon which is stored data required by the processor 111 to form an image upon display panel 121. Display drivers 117, 117′ similarly possess internal memory 51 upon which is stored data required by the display drivers 117, 117′ to form an image or images upon display panels 121′, 121″. In an alternative exemplary embodiment, all of processor 111 and display drivers 117, 117′ can access a central memory 53.

In general, the various embodiments of the mobile station 57 can include, but are not limited to, cellular telephones, portable electronic devices, personal digital assistants (PDAs), portable computers, image capture devices such as digital cameras, gaming devices, music storage and playback appliances, Internet appliances permitting Internet access and browsing, as well as portable units or terminals that incorporate combinations of such functions.

The embodiments of this invention involving the creation of an image or images upon the display device 23 may be implemented by computer software executable by a data processor of the mobile station 57, such as the processor 111, or by hardware, or by a combination of software and hardware.

The memory 53, 51 may be of any type suitable to the local technical environment and may be implemented using any suitable data storage technology, such as semiconductor-based memory devices, magnetic memory devices and systems, optical memory devices and systems, fixed memory and removable memory. The data processor 111 may be of any type suitable to the local technical environment, and may include one or more of general purpose computers, special purpose computers, microprocessors, digital signal processors (DSPS) and processors based on a multi-core processor architecture, as non-limiting examples.

In general, the various embodiments such as controlling the display panels 121, may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Certain embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

What is claimed is:

1. A display device comprising:
a first display panel coupled to a first common voltage; and
at least one additional display panel coupled to at least one additional common voltage,
wherein said first display panel and said at least one additional display panel are coupled to form a single expanse and said first common voltage and said at least one additional common voltage are independently controllable.

2. The display device of claim 1 comprising a display driver coupled to said first display panel.

3. The display device of claim 2 wherein said display driver comprises a graphics card.

4. The display device of claim 2 wherein at least one of said at least one additional display panel is coupled to a display driver.

5. The display device of claim 4 wherein said display driver coupled to said at least one additional display panel comprises a graphics card.

6. The display device of claim 4 wherein each of said display drivers is coupled to a processor.

7. The display device of claim 1 wherein said first common voltage is variable between approximately 0V and 5V.

8. The display device of claim 1 wherein said second voltage is variable between approximately 0V and 5V.

9. The display device of claim 1 comprising a processor coupled to at least one of said first display panel and said at least one additional display panel.

10. The display device of claim 1 wherein said first display panel is coupled to said first common voltage via a first common backplane and said at least one additional display panel is coupled to said at least one additional common voltage via at least one additional common backplane.

11. A display module comprising:
a display device comprising:
a first display panel coupled to a first common backplane; and
a second display panel coupled to a second common backplane,
wherein said first display panel and said second display panel are coupled to form a single expanse;
a source driver having an input coupled to a display data source and an output coupled to said display device; and
a common driver coupled to said source driver and to said first and second common backplane, wherein said common driver controls a first common voltage provided to said first common backplane and a second common voltage provided to said second common backplane.

12. The display module of claim 11 wherein each of said first common voltage and said second common voltage is computed by said common driver.

13. The display module of claim 12 wherein said first common voltage and said second common voltage is computed using said display data.

14. A method of controlling a display device comprising:
providing a display device comprising:
a first display panel coupled to a first common backplane; and
at least one additional display panel coupled to at least one additional common backplane,
wherein said first display panel and said at least one additional display panel are coupled to form a single expanse;
displaying display data on at least one of said first display panel and said at least one additional display panel; and
independently providing at least one common voltage to each of said first common backplane and said at least one additional common backplane on which there is displayed display data.

15. The method of claim 14 comprising computing said at least one common voltage from said display data.

16. The method of claim 15 wherein said computing comprises periodically computing said at least one common voltage.

17. The method of claim 16 wherein said display data comprises a plurality of sequential frames and said at least one common voltage is computed between at least two of said plurality of sequential frames.

18. The method of claim 14 wherein said display device comprises a mobile telephone display device.

19. A portable electronic device comprising:
a display device comprising:
a first display panel coupled to a first common voltage; and
at least one additional display panel coupled to at least one additional common voltage,
wherein said first display panel and said at least one additional display panel are coupled to form a single expanse; and
a processor coupled to said display device for controlling operation of said display device.

20. The portable electronic device of claim 19 comprising at least one display driver coupled to said processor and to at least one of said first display panel and at least one additional display panel.

21. The portable electronic device of claim 19 comprising a memory coupled to said processor for storing graphical data.

22. The portable electronic device of claim 21 wherein said graphical data comprise at least one of a time, a battery strength, a signal strength, a network status, and an operator name.

23. The portable electronic device of claim 19 comprising at least one device driver coupled to at least one of said first display panel and at least one of said at least one additional panel display.

24. The portable electronic device of claim 19 wherein said portable electronic device comprises a mobile phone.

25. A program of machine-readable instructions, tangibly embodied on an information bearing medium and executable by a digital data processor, to perform actions directed toward providing a plurality of common voltages to a display device, the actions comprising:
receiving display data to be displayed on a display device comprising a first display panel coupled to a first common backplane and at least one additional display panel coupled to at least one additional common backplane;
computing a first common voltage and at least one additional common voltage; and
providing said first common voltage to said first common backplane and said at least one additional common voltage to said at least one additional common backplane.

26. The program of claim 25 wherein said computing comprises computing said at least one additional common voltage from said display data.

27. An apparatus comprising:
means for receiving display data to be displayed on a display device comprising a first display panel coupled to a first common backplane and at least one additional display panel coupled to at least one additional common backplane;
means for computing a first common voltage and at least one additional common voltage; and
means for providing said first common voltage to said first common backplane and said at least one additional common voltage to said at least one additional common backplane.

28. The apparatus of claim 27 wherein means for computing comprise means for computing said at least one additional common voltage from said display data.
